(19) United States
(12) Patent Application Publication
(10) Pub. No.: US 2020/0327510 A1
(43) Pub. Date: Oct. 15, 2020

(54) STORED VALUE POINT OF SALE APPLICATION

(71) Applicant: Christopher Eugene Elrod, (US)

(72) Inventor: Christopher Eugene Elrod, (US)

(21) Appl. No.: 16/378,937

(22) Filed: Apr. 9, 2019

(51) Int. Cl. G06Q 20/06; G06Q 20/20; G06Q 20/02; G06Q 20/36; G06Q 30/02

(52) U.S. Cl. CPC G06Q 20/065; G06Q 20/20; G06Q 30/0226; G06Q 20/36; G06Q 20/027

(57) ABSTRACT

The establishment of a stored value point of sale application will give creditors the ability to allow debtors to pay their invoices due while empowering their customers to purchase more.

### BACKGROUND OF THE INVENTION

Point of sale applications and stored value programs have become almost a standard in the way merchants conduct business with consumers. Most of these service providers tout their applications as both time-saving, money-making ways for business owners to manage their business and attract new customers. Yet, with all their capacity, both offerings will only do what they have been programmed to do, and most often for the profit-driven benefit of the provider.

However in a world that's become riddled with debt there is a growing need for these types of products and services to become more than a way of tallying an amount due, or locking in a future customer. While the costs of creating these types of systems are financially feasible for major companies, small business owners, however simply can't afford these sales generating systems and therefore continuously lose the “home field” advantage in the sales war. To make these types of programs available to their clientele, small business owners must collectively work together at the community level to come up with extremely clever ways to compete with major corporations for customers and dollars.

In order for this to be accomplished, small business owners will need the ability to tip the point of sale experience to benefit both them and the customer, if they ever hope have a chance to regain the home ground. This can only be possible if small business owners can drastically reduce or offset expenses in order to establish the types the programs needed to garner customers.

The present invention is in the field of electronic payments.

The present invention is in the technical field of point of sale.

### SUMMARY OF THE INVENTION

The present invention is a cloud-based application that works at the point of sale to enhance the checkout experience by allowing stored value currency to be purchased from a variety of users and immediately redeemed. To accomplish this, the present invention will either create stored value on behalf of the seller or search for stored value being sold by another user. In either case, stored value is created from a debt owed to a creditor that is simply being sold at the point of sale. Upon completion of the stored value purchase, the seller takes ownership of the stored value, and then has the ability to use it as they see fit.

In addition, the present invention capitalizes on its point of sale functionality by allowing users to create turnkey reseller opportunities. This further creates the ability for the present invention to create stored value from commissions earned by the reseller who then has the choice to redeem or sell their stored value for another method of payment.

The present invention will have advancement over currently used systems and methods because it allows multiple users to benefit from a single point of sale experience.

### BRIEF DESCRIPTION OF THE DRAWINGS

FIG. 1 is a flow chart of the method and process steps according to one embodiment of the present invention that shows how stored value can be created.

FIG. 2 is a flow chart of the method and process steps according to one embodiment of the present invention that applies to the trading of stored value between two merchants.

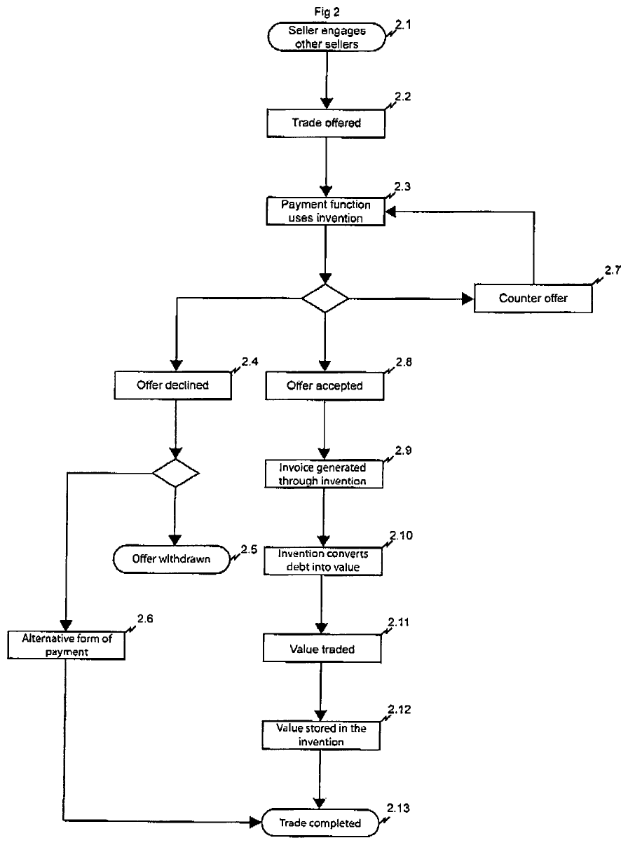

FIG. 3 is a flow chart of the method and process steps according to one embodiment of the present invention that applies to transactions between a merchant and a customer where stored value is purchased with another form of currency.

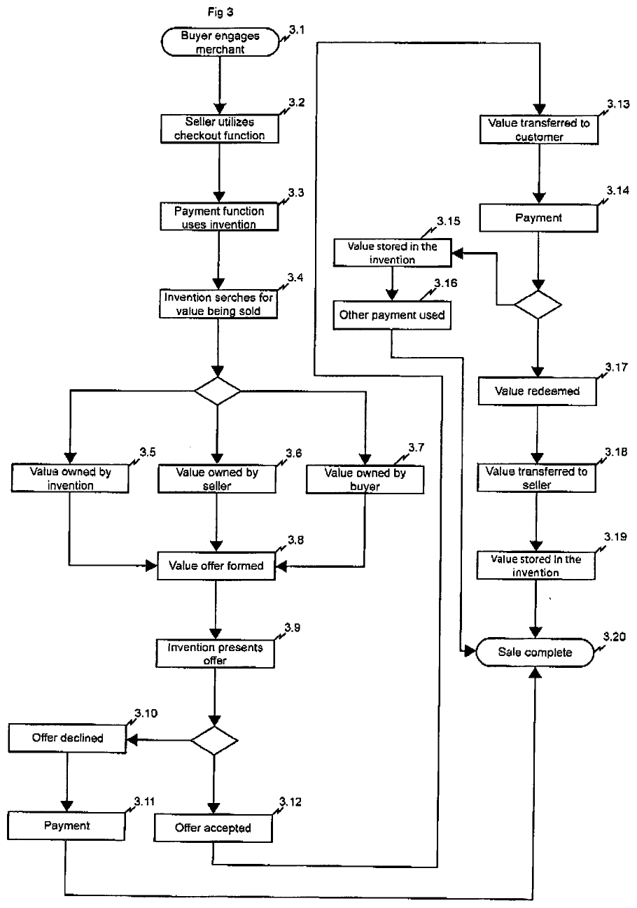

FIG. 4 is a flow chart of the method and process steps according to one embodiment of the present invention that creates reseller opportunities.

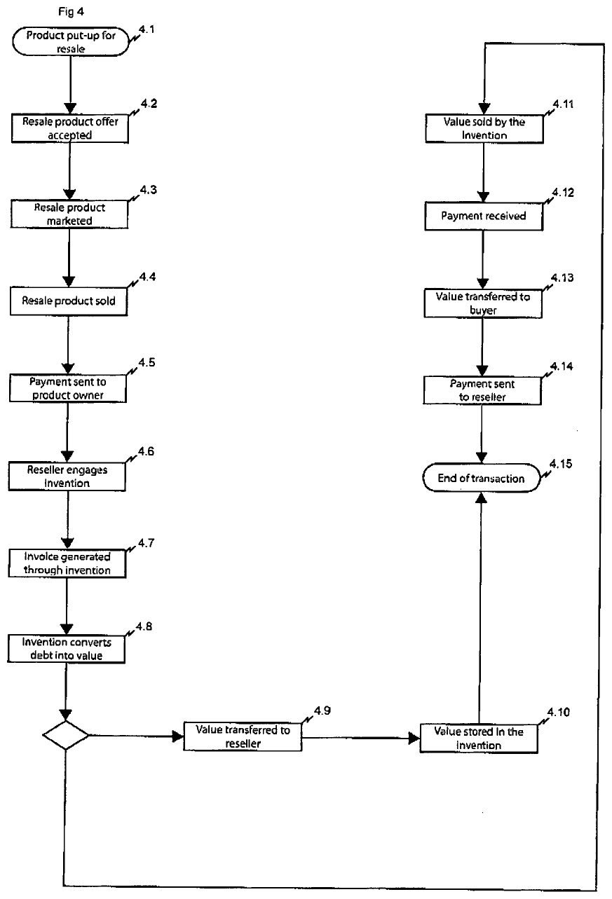

FIG. 5 is a flow chart of the method and process steps according to one embodiment of the present invention that shows actions based upon the decisions made by a user.

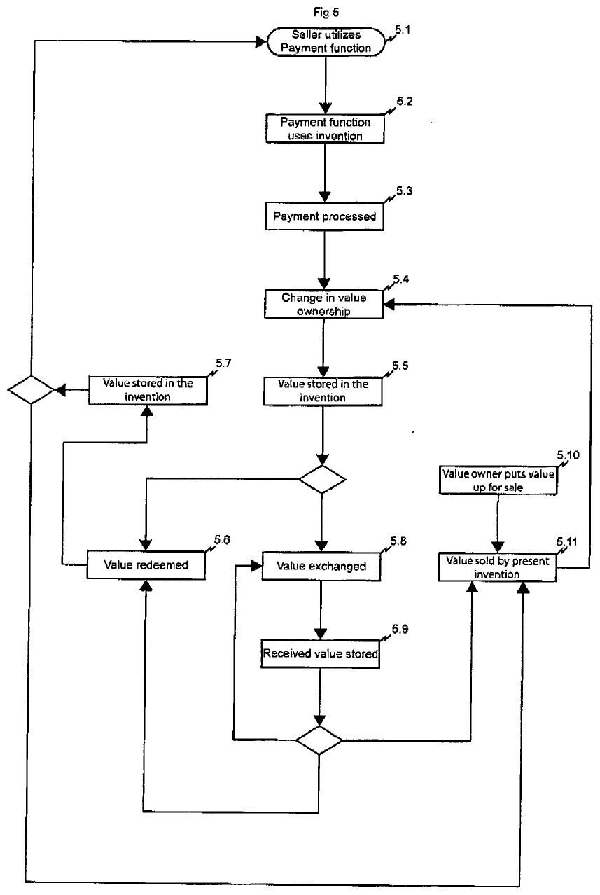

FIG. 6 is a flow chart of the method and process steps according to one embodiment of the present invention that allows users to donate stored value to charity.

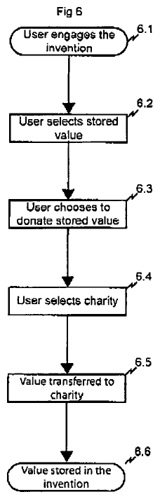

### DETAILED DESCRIPTION OF THE INVENTION

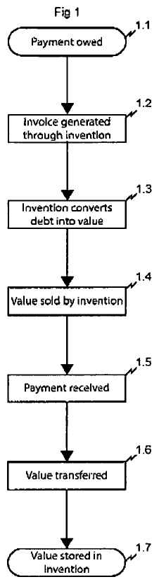

Referring now to the invention in more detail, in FIG. 1, there is shown a flow chart demonstrating one embodiment of the method and process of the present invention.

In one embodiment an invoice or amount due associated with a debt owed can be converted into stored value at the point of sale. In the case of where debt is owed to a user 1 then the user will engage the present invention to generate an invoice 2. Upon the invoice being generated 2 the present invention will then convert the invoice into stored value 3 from a ledger balance that can be sold at the point of purchase. At that time the stored value can be sold 4 and payment received 5 by the original owner of the stored value. Stored value is then transferred 6 to the new owner. Stored value is then housed within the present invention 7.

In one embodiment the present invention will allow sellers to create stored value during the point of sale, similar to barter. At the point of sale, a seller will engage another seller 1 and offer a trade 2 as a means of paying for their purchase. The payment function then uses the present invention 3 to create an offer that can either be accepted 8, countered 7, or declined 4. If buyer accepts 8, then invoice is generated through the present invention 9 which is then converted to value 10, traded 11 with the seller, stored in the seller's account within the present invention 12 and the trade completed 13. If the buyer declines 4, then a decision must be made to use another form of payment 6 or the offer is withdrawn altogether 5. If the buyer counters 7, then buyer engages payment function to use the present invention 3 at which time the process can again be repeated to the desired outcome. Once the trade is completed 13 then stored value is created on behalf of the buyer and immediately transferred to the seller. Seller is now free to use the stored value with the buyer at any point in the future as a payment for their goods and/or services.

In one embodiment the present invention will allow stored value to be purchased at the point of sale. This is accomplished when the buyer engages seller 1 and the seller using the checkout function 2 to determine the amount due. Once the amount due is determined, the payment function 3 will use the present invention to search for stored value 4 owned by the itself 5, the seller 6, or stored value owned by other buyers 7. If stored value is found then an offer is formed 8 by the present invention and is then presented 9 to the customer. If the offer is declined 10, then payment 11 is made with another method and the sale is complete 20. If offer is accepted 12 then payment 13 is made and the stored value transferred 14 to the customer. Upon completing the purchase of stored value 13 and stored value issued 14 then buyer has the option to either store the value 15 and use another payment option 16 to complete the sale 20, or they can choose to redeem the stored value 17 at which time the stored value is transferred to the seller 18 with the stored value now being placed in the seller's account within the present invention 19 and the sale is now complete 20.

In yet another embodiment the present invention will allow sellers to enroll buyers to become resellers of their products and services. In this scenario, a seller places a product up for a resale opportunity 1 and the present invention accepts the product 2 and offers it to potential buyers to allow them to resell the product in exchange for a commission. The product is marketed 3 and when sold 4 the payment for the product is sent to the original seller 5. This allows us to make the assumption that the original seller has now become the reseller's distributor, supplier, or product fulfillment company. When the present invention is engaged 6 to create an invoice 7 of the amount due the reseller in commission. The present invention will convert the invoice into stored value 8 and transfer ownership of the stored value to the reseller 9 at which time it is placed or stored within their account 10 and ultimately they can choose how it is spent. This marks the end of the transaction 15. However, reseller has the option to place their stored value up for sale 11 within the present invention. Once the stored value is sold 11 and the payment processed 12 then the stored value is transferred to the buyer 13 and the payment remitted to the reseller 14. This completes the cycle and marks the end of the transaction 15.

In yet another embodiment the present invention will allow the owners of the stored value to decide on how they will use the stored value. To begin the “decision” tree, the process will begin with the seller utilizing the payment function 1 to determine the amount due from the buyer. The payment function then engages the present invention 2 as to the processing of a payment 3, which creates a change in stored value ownership 4 which is then stored in the buyer's account 5. The user will now have decisions that can be made on how to use their stored value. In the event that the decision is made by the buyer to immediately redeem 6 the stored value to purchase goods and services then the transfer is made and the value stored in the seller's account within the present invention 7. In the event that the decision is made to exchange 8 the stored value with another buyer, then both buyers will both engage the present invention to initiate the exchange 8. Upon the acceptance by both buyers the received stored value 9 is exchanged 8 and the stored value is then received 9 by their new owners and either redeemed 6, sold 11, or the cycle of exchange 8 can continue repeating. In the event that the decision is made to sell the stored value a user holds in their account, then seller will engage the present invention and elect to post their stored value for sell 10 choose their desired method of payment, enter the selling prices, and transmit their stored value offering to their desired marketplace controlled by the present invention. Upon the sell of the stored value 11 all currencies collected, (in the appropriate method of payment) are paid directly to the seller. Stored value ownership is then transferred to the new buyer 4 and the cycle continues.

In yet another embodiment the present invention will allow for stored value to be donated to a charity or non-profit organization. To begin this process a user (a buyer or seller) can engage the present invention 1 to select the option to donate any amount of stored value to the charities of their choice. If the election is made by the user to donate their stored value then user will choose the appropriate stored value 2 select to donate 3, and push the stored value into the present invention for proper credit to the selected charity 4. From there the stored value is transferred to the receiving charity or non-profit organization 5. Value is stored within the present invention 6. Receiver is free to use the stored value as a buyer or seller.

What is claimed:

1. An apparatus comprising:
a point of sale application capable of storing customer, product, sales, order, supplier, vendor, and any other pertinent data associated with the same;
a system capable of creating an order;
a method or system capable of generating an invoice or an amount due;
a debt conversion mechanism capable of converting the invoice or amount due into stored value;
a method or system for temporarily housing the stored value converted from the debt owed;
a processing functionality that allows the stored value to complete the payment for the order;
a payment gateway that allows the transferring of the stored value from the buyer to the seller upon completion of the order;
a virtual wallet in which to keep the stored value;
a marketplace which will allow for the stored value to be sold;
an advertising platform consisting of a application which will allow the stored value to be displayed and marketed to potential buyers;
a loyalty or rewards program that will allow the stored value to be purchased, earned, redeemed, sold, transferred, or donated;

2. The application of claim 1 further allows economic advantages as it allows for the costs of doing business to be offset until the stored value is redeemed for goods or services.

3. The application of claim 1 further allows spawn entrepreneurial opportunities by allowing users to immediately tap into a turnkey business solutions.

4. The application of claim 1 further allows small business owners the ability to compete with major companies by eliminating debt obligations in lieu of stored value redemption.

5. The application of claim 1 further allows communities to socially and financially rebuild themselves.

6. The application of claim 1 will allow users to synchronize products, orders, customer, sales, and shipping data across multiple online marketplaces, and from there have the ability to further control their experience with marketplaces owned by other companies.

7. The application of claim 1 further allows debt that is associated with the costs of goods, operating expenses, or other debts directly or indirectly incurred from acceptable business practices to be monetized at the point of sale.

8. The application of claim 1 further allows for an increase in giving to local charities and non-profit organizations as donations could be made in stored value which is then monetized for the receiver when it is purchased by another user at the point of sale.

9. The application of claim 1 further allows advertising to be purchased and paid for with stored value, This stored value is then used in a manner consistent with one embodiment of the present invention which allows the stored value to be exchanged, sold, or redeemed.

10. The application of claim 1 further allows communities to reestablish social, economic, and financial autonomy and sovereignty by granting the ability to increase tax related revenues from the retention of sales within their respective municipalities.

11. The application of claim 1 further allows for a reduction of the dependence upon social welfare programs, reduces foreclosures, repossessions, and bankruptcies, limits potential court costs, ongoing labor costs, fees regarding lawsuits, judgments, and collections, It reduces unemployment and the costs of unemployment insurance and other unemployment related expenses; health care expenses, child care expenses, and any other costs associated with every day life.

12. The application of claim 1 further allows for the reduction of the need for tariffs, government, transportation, and costs associated with the manufacturing and use of fossil fuels, agricultural sustainment, natural resource management.
